(19) United States
(12) Patent Application Publication
(10) Pub. No.: US 2005/0114308 A1
(43) Pub. Date: May 26, 2005

(54) User customizable reporting

(75) Inventors: Christopher Hyland, Foxboro, MA (US); Fernando Salazar, Arlington, MA (US)

Correspondence Address: CHRISTOPHER & WEISBERG PA, 200 E LAS OLAS BLVD, SUITE 2040, FT LAUDERDALE, FL, 33301, US

(73) Assignee: International Business Machines Corporation, Armonk, NY (US)

(21) Appl. No.: 10/720,404

(22) Filed: Nov. 24, 2003

(51) Int. Cl. G06F 17/30

(52) U.S. Cl. 707/3

(57) ABSTRACT

The present invention is a user customizable report generator. A user customizable report generator can be configured for attachment to at least one database through at least one reporting tool and can include at least one set of pre-established screens for defining at least one value for a corresponding database parameter specified within a report template. The generator further can be communicatively coupled to at least one business rule and the generator can include business rule enforcement logic disposed within each of the pre-established screens. The logic can include programming for processing session state information to assist in enforcing the at least one business rule. Finally, the report generation component can be coupled to the set of pre-established screens and programmed to generate a report definition based upon parameters in a report template and a selection of the pre-established screens for each of the parameters.

### BACKGROUND OF THE INVENTION

1. Statement of the Technical Field

The present invention relates to the field of report generation, and more particularly to the customized use of a reporting tool.

2. Description of the Related Art

Reporting is a function common to a great many computing applications. The general operation of a reporting function is to retrieve selected data from one or more data stores and to render the retrieved data in a formatted document. In this regard, first some limiting criteria for selecting data from the data stores can be specified typically by the end-user requesting the report. Subsequently, the data can be retrieved based upon the limiting criteria. Finally, the data can be formatted into a human readable document and rendered in a user interface.

While reporting tools initially had been included in the distribution of a data driven application, the limitations of the integrated reporting tool often do not provide the flexibility required by the end user. Specifically, the ability of the end user to specify a particular query to the database often can be limited by the interface of the integrated reporting tool. In consequence, independent reporting tools have been developed which directly access the data store without requiring the use of the data driven application.

The prototypical stand-alone reporting tool can include a database adapter configured to facilitate the direct access to a database, a user interface through which the end user can specify query parameters for drawing selected data from the database, a reporting engine configured to formulate suitable queries to the database based upon the specified query parameters, and rendering logic for generating a human readable report based upon the query. Notably, “canned” reports can be created and saved to persistent storage. In this way, reports repeatedly can be produced based upon the canned report without requiring the end user to specify the query parameters each time.

Most reporting tools permit customizations to any report. To establish a customized report through the use of an independent reporting tool, first a template for accessing the database can be created. The template can specify the data fields implicated by the report, and a format for the actual report in terms of a presentation layout. Once the template has been established, limitations for each of the data fields can be specified so that only a subset of the records in the database can be retrieved. Typically referred to as “parameters”, the extent of the report depends upon the nature of the parameter values or value ranges provided for the parameters. Once the parameter values have been specified, the relevant records can be selected, the required data retrieved, and the report generated using the retrieved data and the template.

Despite the flexibility of the stand-alone reporting tool, oftentimes it can difficult for the end user to generate a meaningful report without a deep understanding of the structure of the database. In the absence of a complete documentation of the structure of the database, generating a report can be a nearly impossible task for the uninitiated. Hence, it remains advantageous to generate a report through the operation of the data driven application in as much as the data driven application presumably incorporates the deep knowledge of the structure of the database. Additionally, by controlling access to the reporting tool through the operation of the data driven application, the business rules of the data driven application, including its data access control rules, can be enforced. Yet, generating a report through an integrated reporting tool often precludes a desired level of report customization provided only through a stand-alone report generation tool.

### SUMMARY OF THE INVENTION

The present invention addresses the deficiencies of the art in respect to reporting tool customization and provides a novel and non-obvious method, system and apparatus for creating customized reports in the context of a business application. In accordance with the present invention, a user customizable report generator can be configured for attachment to at least one database through at least one reporting tool and can include at least one set of pre-established screens for defining at least one value for a corresponding database parameter specified within a report template. The generator further can be communicatively coupled to at least one business rule and the generator can include business rule enforcement logic disposed within each of the pre-established screens. The logic can include programming for processing session state information to assist in enforcing the at least one business rule. Finally, the report generation component can be coupled to the set of pre-established screens and programmed to generate a report definition based upon parameters in a report template and a selection of the pre-established screens for each of the parameters.

Each of the screens can include markup language configured for rendering in a content browser and encapsulating script logic for execution in the content browser. For instance, each of the screens can include a Java server page (JSP). At least one business rule can include an access control rule conditioned upon session state information accessible within each of the pre-established screens. The session state information can include information selected from the group consisting of an identity of an end user, a time of day, a date, and a network address for the end user. Moreover, the report definition can include a specified ordering of the selection of the pre-established screens for each of the parameters. Finally, the report generation component can include logic for producing a report based upon the report definition.

A method for generating a user customized report can include the steps of retrieving a specified template for producing a desired report and determining from the specified template a set of parameters required to produce the desired report. For each parameter in the set, a screen can be selected for providing a user interface through which a value can be established for the parameter. Moreover, business rule enforcement logic can be embedded in the selected screen. Finally, each of the selected screens can be saved in a report definition configured to produce a report while executing the embedded business rule enforcement logic. Moreover, an ordering of presentation for the selected screens can be saved in the report definition.

Notably, the report definition can be retrieved and each of the selected screens can be rendered in the stored order. Parameter values can be collected for the parameters in the set through the rendered screens. Yet, the parameter values can be limited according to the embedded business rule enforcement logic. In this regard, session state data such as the user identity can be identified through the rendered screens. The session state data can be processed to limit data input through form fields in the screens. Subsequently, data input can be accepted through the form fields to establish the parameters.

Finally, the report can be generated based upon the collected parameter values. Optionally, the report can be saved for subsequent reuse. In particular, at a later time, the saved report can be loaded and the session state data for an end user loading the saved report can be determined. Advantageously, at least one business rule comparable to a business rule reflected in the embedded business rule enforcement logic can be applied to the session state data. Where necessary, the saved report can be modified to enforce the comparable business rule.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a user customizable reporting tool system;

FIG. 2A is a flow chart illustrating a process for generating a report definition in the system of FIG. 1; and,

FIG. 2B is a flow chart illustrating a process for producing a report based upon the report definition produced in FIG. 2 and according to business rules disposed within the system of FIG. 1.

### DETAILED DESCRIPTION OF THE PREFERRED EMBODIMENTS

The present invention is a user customizable reporting tool, system, method and apparatus. In accordance with the present invention, a user customizable reporting tool can be coupled to a data driven application. The user customizable reporting tool can permit the customized generation of a report definition through the data driven application without comprising the enforcement of business rules associated with the data driven application. Yet, the user customizable reporting tool can permit the complete customization of the report definition by the end user as would ordinarily be the case with a stand alone reporting tool

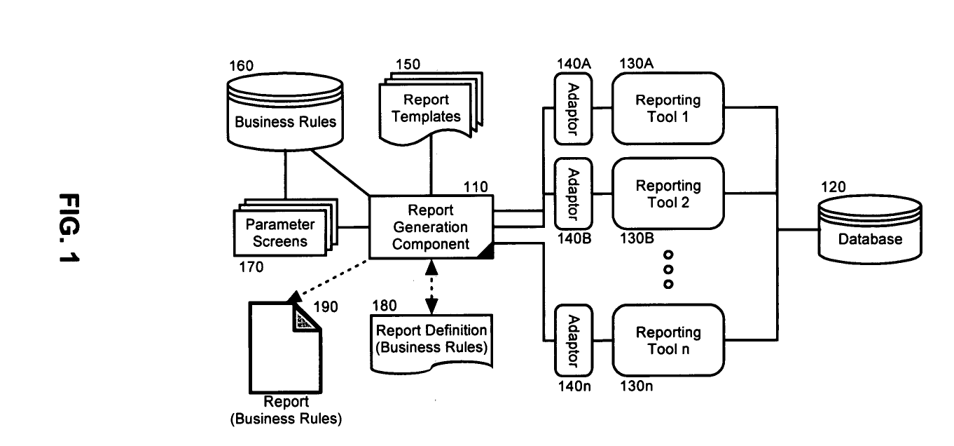

In more particular illustration, FIG. 1 is a schematic illustration of a user customizable reporting tool system. In accordance with the present invention, the database 120 of a data driven application (not shown) can be coupled to one or more reporting tools 130A, 130B, and 130n. Each of the reporting tools 130A, 130B, 130n can include logic for accessing the database 120, for conducting queries against the database 120, and for returning a result set of data to requesting logic. Each reporting tool 130A, 130B, 130n can expose an interface in the form of an adapter 140A, 140B, 140n such that external logic can access the functionality of the reporting tools 130A, 130B, 130n.

A report generation component 110 can be coupled to the adaptors 140A, 140B, 140n and can form the central portion of the system of FIG. 1. The report generation component 110 can be further coupled to a store of report templates 150. The report templates 150 can be produced by the reporting tools 130A, 130B, 130n and can incorporate a format for producing a report which can specify both a presentation view of the format and a data view of the format. In this regard, the data view can specify which data fields, or parameters are to be presented in the report. By comparison, the presentation view of the format can specify a visual arrangement for the parameters in the report.

The report generation component 110 can be configured to produce both report definitions 180 and reports 190. The report definitions 180 can specify a specific report incorporating data from the database 120 which has been limited by pre-specified parameter values. Moreover, the format of the specific report can comport with the visual format specified by a selected one of the templates 150. Once a report definition 180 has been created, reports 190 can be created on demand which reflect the specification of corresponding report definitions 180.

Importantly, at the time of generating a report 190 or a report definition 180, it will be necessary for the end user to specify selection values for the parameters in a selected one of the templates 150. As it will be recognized by the skilled artisan, the specification of the values can be controlled through the presentation of a user interface, Through the user interface, the end user can specify the values or range of values for the parameters. Accordingly, a set of parameter screens 170 can be coupled to the report generation component 110. Preferably, the parameter screens 170 can be defined as a dynamically renderable hypermedia document, for instance a JSP.

Notably, ordinarily only one of the parameter screens 170 will be required to establish a value or range of values for a parameter. Nevertheless, alternative ones of the parameter screens 170 further can be provided to accomplish different interface objectives, though all of the parameters screens 170 for a particular parameter ultimately can establish a value or range of values for the same parameter. Such would be the case, for instance, to accommodate different languages or perhaps to accommodate units. In any event, at the time of constructing a report definition 180, the end user can select a preferred parameter screen from among the parameter screens 170.

Significantly, one or more business rules 160 can be coupled to selected ones of the parameter screens 170. The business rules 160 can include, for instance, rules for accessing data in the database 120. Typical ones of the rules 160 can restrict any query to a sub-set of the data stored in the database 120. As an example, it may be preferable to limit access to certain data in the database 120 based upon the specific identity of the querying user, or the class of the querying user. Importantly, at the time of constructing the report definition 180, the parameter screens 170 can limit the specification of values for the parameters so as to enforce the business rules 160.

Preferably, the business rules 160 further can be coupled to the report generation component 110. In particular, at the time of producing a report 190, the report generation component 110 can enforce the business rules 160 a second time by comparing the state of the report generation component 110 to the business rules 160. For instance, the identity of the end user can be compared to the business rules 160 to ensure that the values specified for the parameters of the report definition 180 are permitted under the business rules 160 for the specific end user.

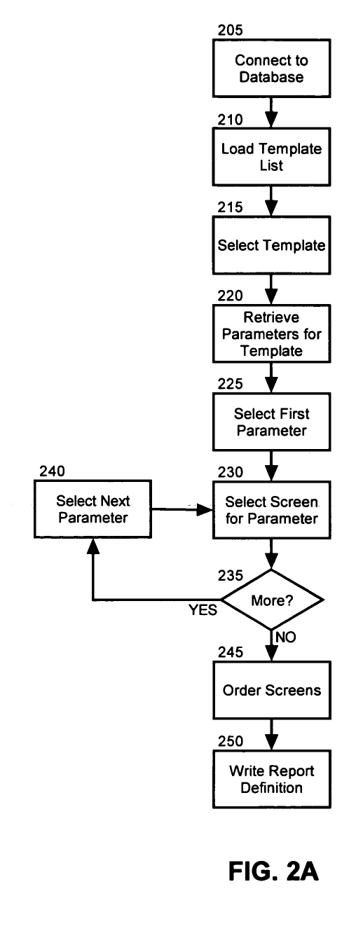

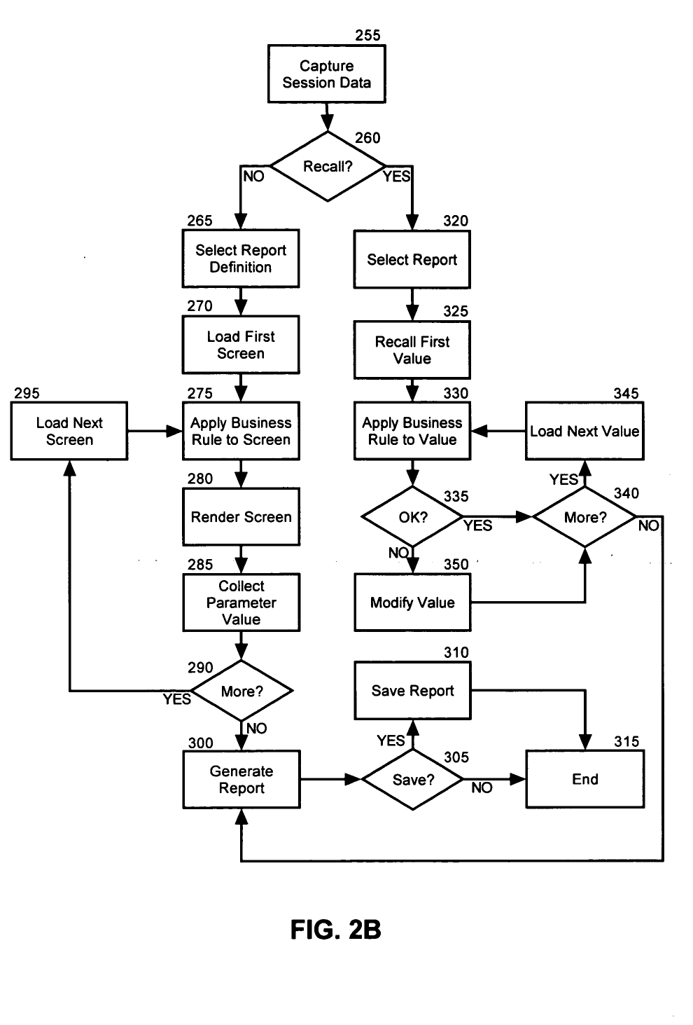

In further illustration of the operation of the system of FIG. 1, FIG. 2A is a flow chart illustrating a process for generating a report configuration in the system of FIG. 1. Beginning in block 205, initially the report generation component can connect to the database through a selected reporting tool and in block 210 a template list can be loaded. In block 215 a particular template can be selected and in block 220 the parameters for the particular template can be retrieved. In block 225 a first parameter from among the retrieved parameters can be selected. In block 230 a screen for the parameter can be selected from among a set of screens.

In this regard, multiple screens can be associated with a single parameter, yet only one screen can be selected for establishing a value or range of values for the parameter. In any case, in decision block 235, it can be determined if additional parameters remain to be processed. If so, in block 240 the next parameter from among the retrieved parameters can be selected and a screen can be chosen for the retrieved parameter from among another set of screens. The process can repeat for all of the parameters retrieved from the template. Once the screens have been selected for the parameters, in block 245 the presentation order of the screens can be established. Finally, in block 250 the identity and ordering of the screens can be written to a report definition.

Once a report definition has been established, reports can be generated through operation of the report generation component. In particular, FIG. 2B is a flow chart illustrating a process for producing a report based upon the report definition produced in FIG. 2 and according to business rules disposed within the system of FIG. 1. Initially, an end user can initiate the operation of the report generation component, responsive to which, in block 265, the session data associated with the end user can be captured. Notably, the session data can include the identity of the end user and the network address associated with the end user.

It will be recognized by the skilled artisan that a report can be generated either initially based upon an established report definition, or by way of a pre-configured report which had been established based upon a report definition. As a result, initially in decision block 260 it can be determined whether the report is to be generated based upon a report definition, or an already existing report. If the report is to be generated based upon a report definition, in block 265 a report definition first can be selected responsive to which values can be established for each of the report parameters through a sequence of screens specified within the report definition.

Specifically, in block 270 the first specified screen can be loaded and in block 275 the business rules of the screen can be applied. In particular, to the extent that a selection of data in the database can be limited to a selection of a sub-set of data based upon particular business rules such as the identity of the end user, the screen can limit the specification of the values or value ranges for the parameters accordingly. As an example, where the end user is a sales manager belonging to a particular sales region, the value permitted for a parameter relating to sales data can be limited to sales data for the particular sales region.

In any case, once the data set has been limited according to the business rules, in block 280 the screen can be rendered and in block 285 the parameter value can be established at the instruction of the end user. The screen rendering process, regulated of course by the business rules, can continue through decision block 290 for all remaining screens defined in the report definitions. Once the parameter values for the report have been established through the operation of the screens, in block 300 the report can be generated. In decision block 305, the end user optionally can save the report for future use. In either case, the process can end in block 315.

Returning now to decision block 260, where the end user has instructed the generation of a report based upon a previously saved report, in block 320 the previously saved report can be generated. Still, noting that the state of the report generation component may have changed since the creation of the previously saved report, the business rules again can be enforced based upon the current state of the report generation component. In this regard, in block 325, the first parameter value can be recalled and in block 330 the business rules can be applied to the value.

If in decision block 335 the use of the parameter value does not violate the business rules, the next parameter value in the previously saved report can be checked against the business rules and the process can continue for all remaining parameter values in blocks 340 and 345. Whenever a parameter value violates any one of the business rules, in block 350 the value can be brought within range of the violated business rule. Once the business rules have been enforced entirely, in block 300 the report can be generated and, once again, the end user in block 305 can be given the option to the save the report before the process can end in block 315.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A user customizable report generator comprising a configuration for attachment to at least one database through at least one reporting tool, the generator comprising:
at least one set of pre-established screens for defining at least one value for a corresponding database parameter specified within a report template;
a communicative coupling to at least one business rule;
business rule enforcement logic disposed within each of said pre-established screens, said logic comprising programming for processing session state information to assist in enforcing said at least one business rule; and,
a report generation component coupled to said set of pre-established screens and programmed to generate a report definition based upon parameters in a report template and a selection of said pre-established screens for each of said parameters.

2. The report generator of claim 1, wherein each of said screens comprises markup language configured for rendering in a content browser and encapsulating script logic for execution in said content browser.

3. The report generator of claim 1, wherein each of said screens comprises a Java server page (JSP).

4. The report generator of claim 1, wherein said at least one business rule comprises an access control rule conditioned upon session state information accessible within each of said pre-established screens.

5. The report generator of claim 4, wherein said session state information comprises information selected from the group consisting of an identity of an end user, a time of day, a date, and a network address for said end user.

6. The report generator of claim 1, wherein said report definition comprises a specified ordering of said selection of said pre-established screens for each of said parameters.

7. The report generator of claim 1, wherein said report generation component further comprises logic for producing a report based upon said report definition.

8. A method for generating a user customized report comprising the steps of:
retrieving a specified template for producing a desired report;
determining from said specified template a set of parameters required to produce said desired report;
for each parameter in said set, selecting a screen for providing a user interface through which a value can be established for said parameter, and embedding business rule enforcement logic in said selected screen; and,
saving each of said selected screens in a report definition configured to produce a report while executing said embedded business rule enforcement logic.

9. The method of claim 8, further comprising the step of storing an order of presentation for said selected screens in said report definition.

10. The method of claim 9, further comprising the steps of:
retrieving said report definition;
rendering each of said selected screens in said stored order;
collecting parameter values for said parameters in said set through said rendered screens while limiting said parameter values according to said embedded business rule enforcement logic; and,
generating said report based upon said collected parameter values.

11. The method of claim 10, wherein said collecting step comprises the steps of:
identifying session state data through said rendered screens;
processing said session state data to limit data input through form fields in said screens; and,
accepting data input through said form fields to establish said parameters.

12. The method of claim 11, wherein said processing step comprises the steps of:
identifying an end user through said session state data;
limiting a range of data which can be accessed in said report based upon an identity of said end user as processed through said embedded business rule enforcement logic; and,
reflecting said limited range of data through data input restrictions applied to said form fields in said screens.

13. The method of claim 10, further comprising the step of saving said report for subsequent reuse.

14. The method of claim 13, further comprising the steps of:
loading said saved report;
determining session state data for an end user loading said saved report;
applying at least one business rule comparable to a business rule reflected in said embedded business rule enforcement logic to said session state data; and,
modifying said saved report to enforce said at least one comparable business rule.

15. A machine readable storage having stored thereon a computer program for generating a user customized report, the computer program comprising a routine set of instructions which when executed by the machine cause the machine to perform the steps of:
retrieving a specified template for producing a desired report;
determining from said specified template a set of parameters required to produce said desired report;
for each parameter in said set, selecting a screen for providing a user interface through which a value can be established for said parameter, and embedding business rule enforcement logic in said selected screen; and,
saving each of said selected screens in a report definition configured to produce a report while executing said embedded business rule enforcement logic.

16. The machine readable storage of claim 15, further comprising the step of storing an order of presentation for said selected screens in said report definition.

17. The machine readable storage of claim 16, further comprising the steps of:
retrieving said report definition;
rendering each of said selected screens in said stored order;
collecting parameter values for said parameters in said set through said rendered screens while limiting said parameter values according to said embedded business rule enforcement logic; and,
generating said report based upon said collected parameter values.

18. The machine readable storage of claim 17, wherein said collecting step comprises the steps of:
identifying session state data through said rendered screens;
processing said session state data to limit data input through form fields in said screens; and,
accepting data input through said form fields to establish said parameters.

19. The machine readable storage of claim 18, wherein said processing step comprises the steps of:
identifying an end user through said session state data;
limiting a range of data which can be accessed in said report based upon an identity of said end user as processed through said embedded business rule enforcement logic; and,
reflecting said limited range of data through data input restrictions applied to said form fields in said screens.

20. The machine readable storage of claim 17, further comprising the step of saving said report for subsequent reuse.

21. The machine readable storage of claim 20, further comprising the steps of:
loading said saved report;
determining session state data for an end user loading said saved report;
applying at least one business rule comparable to a business rule reflected in said embedded business rule enforcement logic to said session state data; and,
modifying said saved report to enforce said at least one comparable business rule.
